(19) United States
(12) Patent Application Publication
(10) Pub. No.: US 2010/0132832 A1
(43) Pub. Date: Jun. 3, 2010

(54) Filling Device

(75) Inventor: Walter Neumayer, Worth/Donau (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: KRONES AG, Neutraubling (DE)

(21) Appl. No.: 12/620,700

(22) Filed: Nov. 18, 2009

(30) Foreign Application Priority Data
Dec. 3, 2008 (DE) 102008060379.1

(51) Int. Cl. B65B 3/28; G01G 19/00

(52) U.S. Cl. 141/83; 177/245

(57) ABSTRACT

A filling device for containers, particularly for beverage bottles, having a filling valve, a holder for the container in suspended arrangement, as well as a weighing device. To make the weighing device robust and the measurement more precise, the weighing device is assigned to the holder in close vicinity.

### CROSS-REFERENCE TO RELATED APPLICATION

The present application claims the benefit of priority of German Patent Application No. 10 2008 060 379.1, filed Dec. 3, 2008. The entire text of the priority application is incorporated herein by reference in its entirety.

### FIELD OF THE DISCLOSURE

The present disclosure relates to a filling device for containers, particularly for beverage containers.

### BACKGROUND

Such a filling device is known from EP 1 025 424. The known filling device contains one of the standard filler carousels that extend around a substantially vertical axis and are provided on their outer circumference with radially projecting holders for the containers. The holders are normally configured in the form of tongs, the two tong jaws being spring-loaded or magnetically attracted to each other and comprising a recess adapted to the container, with which jaws the holder grips around the container for filling purposes. Normally, bottles are filled that are provided underneath the filling opening, on their neck, with a protruding flange which offers a support on the upper side of the holder. For the filling operation a filling valve is provided that is in coaxial alignment with the filling opening of the container with its outlet in the filling position. A predetermined quantity of the product is filled into the container by operating the filling valve. To control the filled state, the container is weighed. For this purpose a weighing device is provided that contains an elastically deformable element in the form of an elastic bar which is rigidly secured to the frame and the deformation of which, caused by the weight of the container, is detected and evaluated as a measure of the weight. The elastic element is acted upon by the holder, the elastic element and the holder being positioned side by side in radial direction with respect to the rotational axis of the filler carousel. The holder serves as a lever arm for acting on the elastically deformable bar. Due to this horizontally and radially extending arrangement the known weighing device is, however, relatively sensitive to vibrations caused by the operation, which arise due to the rotation of the filler carousel or due to forces, or the like, acting on the container for a short period of time. These vibrations may distort the weighing result.

### SUMMARY OF THE DISCLOSURE

It is the object of the present disclosure to provide a filling device comprising a robust and reliable weighing device.

Due to the nearby arrangement of the weighing device the impact of vibrations acting on the weighing device is eliminated, or vibrations cannot build up for lack of leverage.

A particularly preferred arrangement of the weighing device is provided above, namely substantially vertically above, the holder, whereby a connection substantially protected against vibrations in the direction of gravity is possible between the container and the weighing device.

Expediently, the holder is directly connected to the weighing device via at least one substantially vertically extending arm.

An even better protection against undesired vibrations is offered by a weighing device arranged substantially in symmetry with the filling axis, the weighing device being provided on at least two opposite sides of the filling axis, the filling axis, however, preferably extending through an opening in the weighing device. This can be achieved in a constructionally simple way in that the weighing device extends around the outlet of the filling valve.

Such a design of the weighing device can be achieved in a constructionally particularly simple and reliable way by means of an elastic element the deformation of which, caused by the weight of the container, is detected. Such an elastically deformable element can be configured without difficulty to be closed in the form of a ring around the filling axis and/or the filling valve.

### BRIEF DESCRIPTION OF THE DRAWINGS

An embodiment of the present disclosure will now be explained in more detail with reference to the drawings, in which:

FIG. 1 is a perspective illustration showing part of a filling device configured according to the disclosure;

FIG. 2 is a side view of the filling device according to FIG. 1; and

FIG. 3 is a front view of the filling device according to FIGS. 1 and 2.

### DETAILED DESCRIPTION OF THE PREFERRED EMBODIMENT

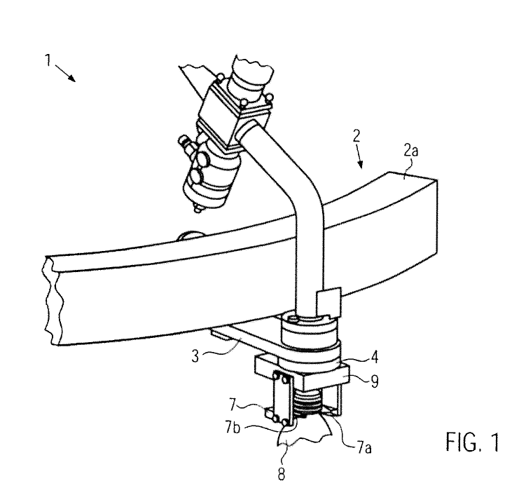

FIG. 1 shows a filling device 1 as part of a filling system for filling drinks, which device is e.g. a conventional filler carousel and includes a frame 2 rotatingly driven about a substantially vertical axis of rotation 2′ in rotational direction D. In the illustrated embodiment only part of an outer hoop-like support member 2a, which extends about the rotational axis 2′, can be seen of frame 2.

A support 3 which extends in radial direction with respect to the axis of rotation 2′ beyond the support member 2a is fastened to the support member 2a. Said support 3 is configured as a valve accommodating means for a filling valve 4. The filling valve 4 is of a standard type and is connected via a supply line 4 and via a conventional distributor 6 to a source for product to be filled, particularly a beverage. The filling valve 4 is arranged such that its outlet is arranged in the form of a filling nozzle 4 with a substantially vertical center line 6′ and a substantially horizontally extending outlet opening 6a.

A holder 7 for containers 8 to be filled, shown are bottles with a handling flange 8a provided on the neck and a container centerline 8′, is arranged vertically underneath the outlet opening 6a.

The holder 7 includes the lateral jaws 7a and 7b, respectively, configured in the conventional way as tongs, which comprise an accommodating opening adapted to the container and an upper support area for the handling flange 8a and are loaded in their closing position via a spring (not shown). The resilient or magnetic force is of such a kind that the jaws 7a, 7b will move apart from each other when a container 8 presses in radial direction inwards against the jaws, and they will again move towards each other in the closing position as soon as the container 8 has reached the recess of the jaws. As a result the jaws move underneath the handling flange 8a and retain the container 8 for filling purposes in suspended fashion in a substantially axial orientation of the container axis 8′ relative to the filling axis 6′.

In the illustrated embodiment the jaws 7a, 7b of the holder 7 are not directly secured to the frame 2, but are fastened to a weighing device 9. The weighing device may have any structure that is able to detect a weight freely suspended from said device. Preferably, the weighing unit comprises an elastically deformable element the deformation of which can be detected by measuring devices, such as e.g. strain gauges or the like. Such elastic elements are known in the case of weighing devices and need not be explained any more.

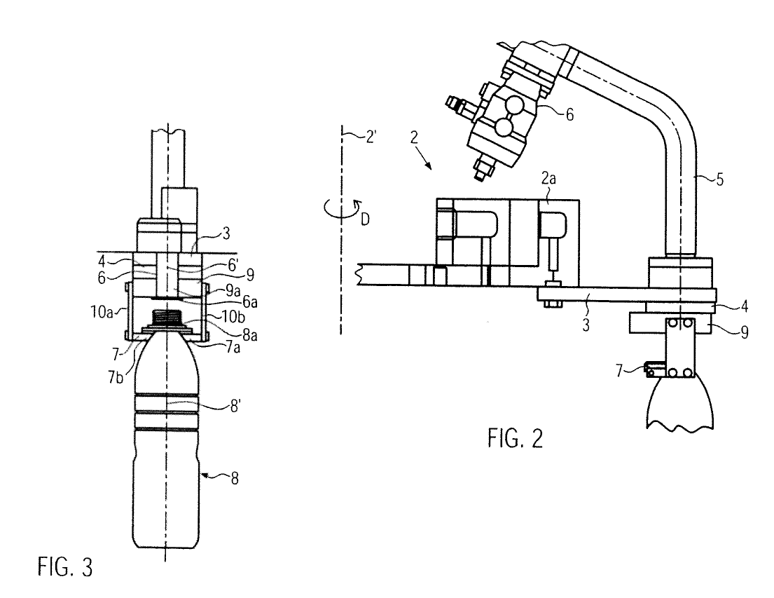

The weighing device 9 is arranged in the illustrated embodiment underneath the filling valve 4 on at least two opposite sides of the filling axis 6′ in such a way that the container 8 can be filled straight through the weighing device 9. Preferably, the weighing device 9 extends in a closed circle around the filling axis 6′, and it is here evident that the filling nozzle 6 could be guided through an opening 9a in the weighing device 9. The outer shape of the weighing device 9, however, can be asymmetrical with respect to the filling axis and can e.g. be at a right angle, as becomes apparent from FIGS. 1 and 2.

The holder 7 is suspended from the weighing device via at least one, preferably two, substantially vertically extending arms 10a, 10b. The arm or arms 10a, 10b represent the sole mounting of the holder 7 and thus of the container 8 on the frame 2. The arms 10a, 10b act in symmetry with respect to the filling axis 6′ and at the same distance from the filling axis 6′ on the weighing device 9′, the distance from the filling axis 6′ being kept so small as is permitted by the neck diameter of the container 8 so as to minimize or avoid any leverage. The arms 10a, 10b are positioned at the side of the weighing device 9 which is advancing or trailing, respectively, in rotational direction. The mounting points of the arms 10a, 10b on the holder 7 on the one hand and the weighing device 9 on the other hand have the same distance from one another in rotational direction D and are arranged in symmetry with respect to the filling axis 6′ so that the arms 10a, 10b can extend optimally in vertical direction.

The weighing device 9 and the holder 7 are configured such that the two can be arranged nearby or in close vicinity relative to each other, i.e. as closely adjacent as possible, to avoid any long leverage. To be more specific, the holder 7 and the weighing device 9 are spaced apart from each other at a distance just sufficient to accommodate the container 8 above the handling flange 8a between the holder and the outlet opening 6a, the outlet opening 6a preferably ending with the lower boundary of the weighing device 9. Thus the arms 10a, 10b extend exactly vertically.

In a modification of the described and illustrated embodiments the weighing device may optionally also be arranged above the filling valve or at another place along the filling axis 6′. The arms for the suspension of the holder may also extend (slightly) obliquely with a correspondingly stiff configuration. Preferably, the weighing device contains an elastically deformable material, the deformation of which is picked up in a known way, for example through the strain gauge, and is transmitted to a control and/or display device for evaluation. Other constructional configurations of a weighing device, of which many are available on the market, are also possible.

1. A filling device for containers, particularly for beverage bottles, comprising a filling valve, a holder for the container in suspended arrangement, and a weighing device which is assigned to the holder in close vicinity.

2. The filling device according to claim 1, wherein the weighing device is arranged substantially vertically above the container which is positioned in the holder.

3. The filling device according to claim 1, wherein the holder is connected to the weighing device through at least one substantially vertically extending arm.

4. The filling device according to claim 1, wherein the weighing device is arranged on at least two opposite sides and in symmetry with the filling axis.

5. The filling device according to claim 2, wherein the container is filled straight through the weighing device.

6. The filling device according to claim 1, and an outlet of the filling valve extends through the weighing device.

7. The filling device according to, wherein the weighing device contains an element which is elastically deformable by the weight of the container.

8. The filling device according to claim 7, wherein, the elastically deformable element is closed in the form of a ring and comprises an opening for the filling operation.
